(19) United States
(12) Patent Application Publication
(10) Pub. No.: US 2020/0031267 A1
(43) Pub. Date: Jan. 30, 2020

(54) TRUCK RAMP ASSEMBLY FOR SNOWMOBILES

(71) Applicant: Matthew M. Pelzer, Redfield, IA (US)

(72) Inventor: Matthew M. Pelzer, Redfield, IA (US)

(21) Appl. No.: 16/047,848

(22) Filed: Jul. 27, 2018

(51) Int. Cl. B60P 1/43; B65G 69/28; B60P 3/06; B60P 3/40; B60P 1/64

(52) U.S. Cl. CPC B60P 1/435; B65G 69/2811; B60P 1/64; B60P 3/40; B60P 3/062

(57) ABSTRACT

A ramp assembly for loading and unloading a snowmobile to and from a pickup truck bed is mounted to the hitch receiver of the truck and extends rearwardly behind the open tailgate. The ramp assembly includes a pair of spaced apart ski ramps pivotally mounted for movement between a lowered used position and a raised transport position. A center ramp between the ski ramps supports the drive belt of the snowmobile during loading and unloading. A pedestal on the ramp assembly supports the rear end of the snowmobile beyond the truck tailgate when the snowmobile is fully loaded into the truck bed. The center ramp of the assembly is removable for storage and transport and while the truck is being driven.

### CROSS-REFERENCE TO RELATED APPLICATIONS

This application claims priority to Provisional Application U.S. Ser. No. 62/541,915, filed on Aug. 7, 2017, which is herein incorporated by reference in their entirety.

### FIELD OF THE INVENTION

The present invention is directed to a ramp for driving a snowmobile into and out of the bed of a pickup truck.

### BACKGROUND OF THE INVENTION

Pickup truck beds typically are 5-8 feet long. Some trucks include a box for tools or other objects extending across the front of the truck bed, which effectively shortens the length of the bed. It is sometimes desirable to transport objects in the bed which are longer than the bed, and extend beyond the tailgate, even when the tailgate is down. For example, the owner of a snowmobile may wish to haul the snowmobile the truck bed, but the length is too long for the bed and the tailgate cannot be closed. Also, a ramp must be used to load and unload the snowmobile. One option for transporting a snowmobile, or other lengthy objects, is the use of a trailer pulled behind the truck. However, a trailer requires additional driving skills, and has its own costs and licensing requirements and fees.

Another alternative for hauling long objects, such as snowmobiles, is the use of a truck bed extender which typically mounts to the bed of the truck or the hitch receiver of the truck. Conventional truck bed extenders require a separate ramp or ramps which must be loaded and unloaded in the truck bed so that the snowmobile can be driven to and from the truck bed, which is inconvenient, time consuming, and often times difficult for one person to handle due to the size and weight of the ramp or ramps.

Therefore, a primary objective of the present invention is the provision of an improved ramp assembly for loading and unloading a snowmobile to and from a truck bed.

A further objective of the present invention is the provision of a truck ramps which pivot between an inclined used position and a raised transport position.

Another objective of the present invention is the provision of snowmobile ramps for driving a snowmobile on and off a pickup truck bed.

Still another objective of the present invention is the provision of a truck bed snowmobile ramp assembly which largely does not need to be removed when the truck is driven.

Yet another objective of the present invention is the provision of a snowmobile truck bed ramp assembly having telescoping and/or folding ramps.

A further objective of the present invention is the provision of a snowmobile ramp assembly having spaced apart ski ramps and a center belt ramp. Another objective of the present invention is the provision of a ramp assembly for mounting to the hitch receiver of a pickup truck to load and unload a snowmobile into and out of the truck bed.

Yet another objective of the present invention is the provision of a ramp assembly for loading and unloading a snowmobile into a truck bed which supports the rear end of the snowmobile beyond the open tailgate of the truck.

A further objective of the present invention is the provision of a pickup truck ramp assembly which can be used for both snowmobiles and four-wheeled vehicles.

Another objective of the present invention is the provision of a ramp assembly for pickup trucks wherein the ramps have upper and lower surfaces which can be reversed for loading and unloading different vehicles into the truck bed.

A further objective of the present invention is the provision of a snowmobile ramp assembly for use with a pickup truck wherein the ramp assembly is quick and easy to set up and take down.

Another objective of the present invention is the provision of a truck bed extender which mounts to the hitch receiver of a pickup truck to extend the bed of the truck for hauling elongated objects which extend beyond the open tailgate of the truck.

A further objective of the present invention is the provision of a ramp assembly for a pickup truck having brake lights electrically coupled to the truck's braking system.

Still another objective of the present invention is the provision of a truck bed extender and ramp assembly which is adjustable to accommodate various truck models.

Another objective of the present invention is the provision of a truck bed extender with ramps, wherein the assembly is economical to manufacture, light weight, and durable, safe, and simple to use.

These and other objectives will become apparent from the following description of the invention.

### SUMMARY OF THE INVENTION

A snowmobile ramp assembly is provided for driving a snowmobile into and out of a pickup truck bed. The assembly includes a tongue adapted to be mounted in the hitch receiver of a pickup truck and extending rearwardly beyond an open tailgate of the truck.

A crossbar is mounted adjacent the rearward end of the tongue. A pair of ski ramps for the snowmobile skis are pivotally mounted on the crossbar so as to be pivotal between a loading/unloading use position and a raised transport position. A center ramp is removably attached to the cross bar and supports the snowmobile track or belt when the snowmobile is driven up and down the ramp to and from the truck bed. The ski ramps remain on the crossbar when the truck is driven and include telescoping sections as to shorten the overall length of the ramps during transportation. The center ramp is removed before the truck is driven. An upstanding pedestal on the tongue supports the rear of the snowmobile, behind the open tailgate, when the snowmobile is in the truck bed. Brake lights can be provided on the assembly and electrically coupled to the truck's brake system. The crossbar is adjustably mounted on the tongue so that the position between the tailgate and the crossbar can be increased or decreased, as needed on different truck models.

### BRIEF DESCRIPTION OF THE DRAWINGS

FIG. 1 is a perspective view of the truck ramp assembly for use with snowmobiles, in accordance with the present invention.

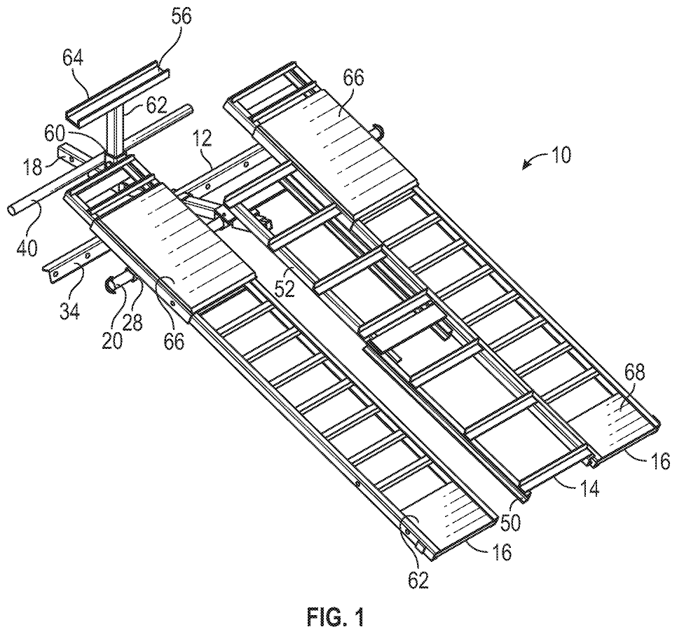

FIG. 2 is a perspective view showing the ramp assembly mounted to the hitch receiver of a pickup truck, and with the center ramp and pedestal removed for clarity.

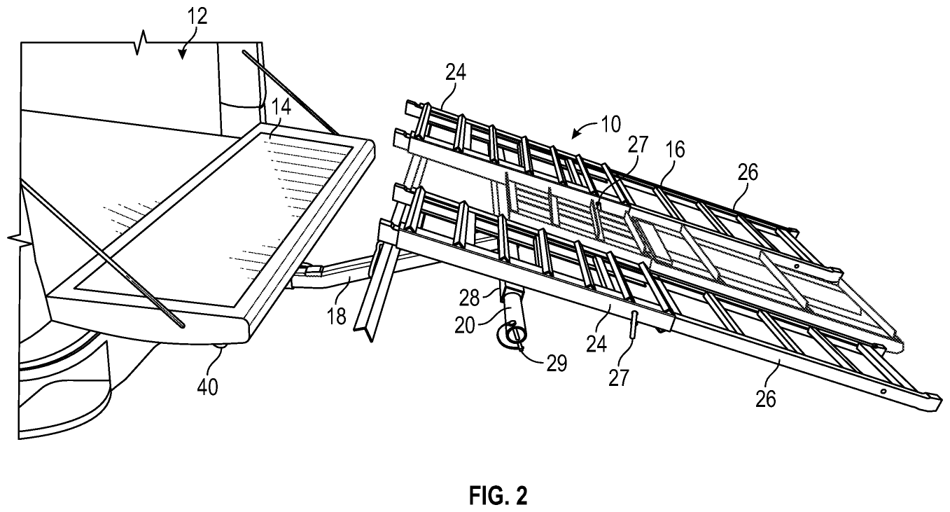

FIG. 3 is a rear end view of the ramp assembly of the present invention mounted on the truck.

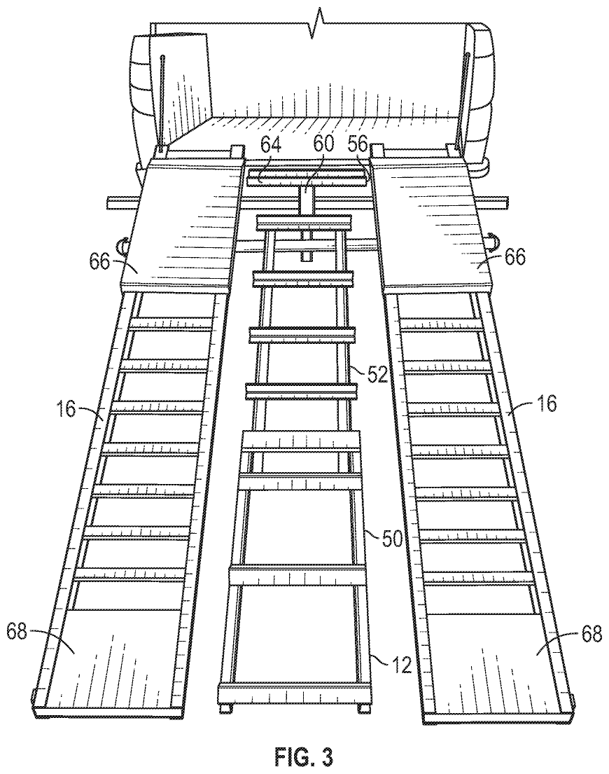

FIG. 4 is a side elevation view of the ramp assembly with a snowmobile at the bottom of the ramps.

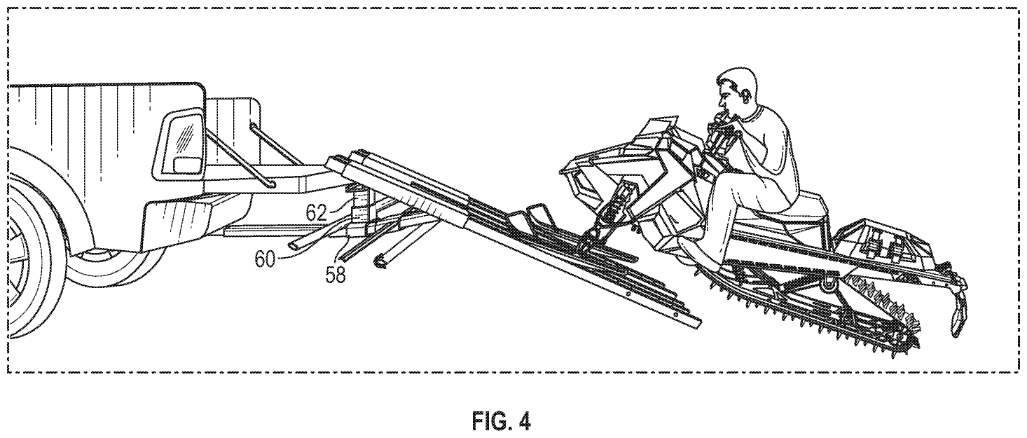

FIG. 5 is a side elevation view of the ramp assembly with a snowmobile on the the ramps.

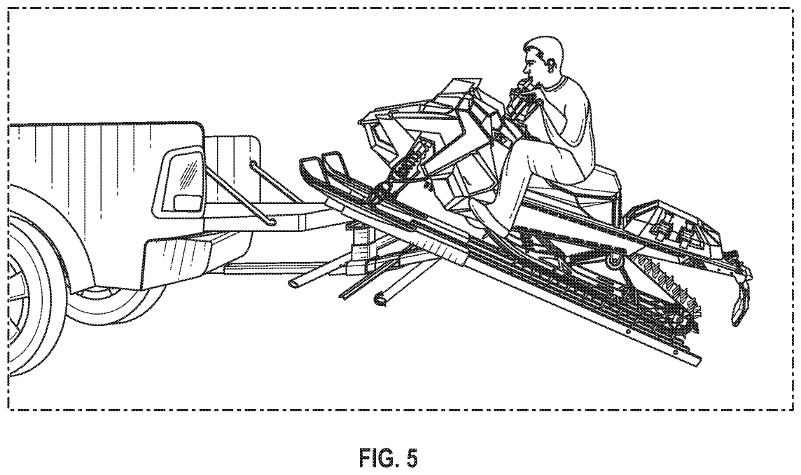

FIG. 6 shows the snowmobile loaded into the truck bed, and with the ramp assembly in a transport position.

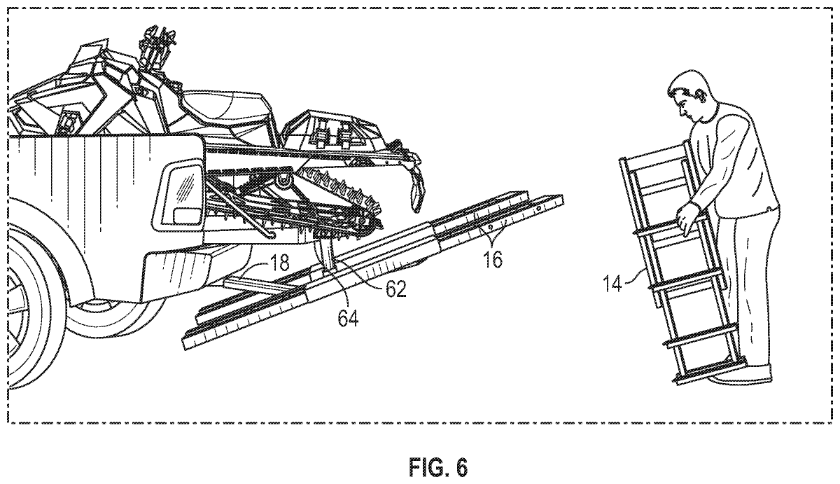

FIG. 7 shows the center ramp with the upper and lower sections partially folded.

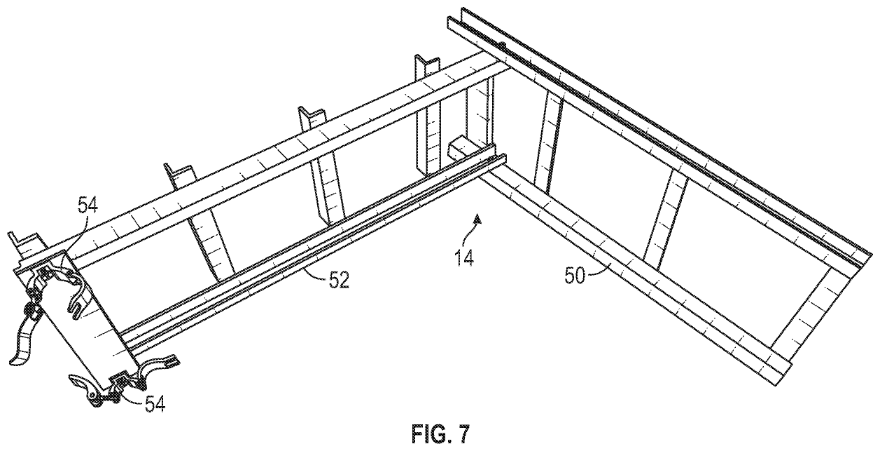

### DETAILED DESCRIPTION OF THE INVENTION

The ramp assembly 10 of the present invention is intended for use in loading and unloading a snowmobile to and from pickup truck bed. The truck has a tailgate which is movable between a raised closed position and a lowered open position. The ramp assembly 10 generally includes a frame 12, a center ramp 14 detachably mounted on the frame 12 for the snowmobile track or belt, and a pair of side ramps 16 pivotally mounted on the frame for the snowmobile skis. The structure and function of the frame 12 and the ramps 16 are fully shown and described in Applicant's U.S. Pat. No. 9,745,153, which is incorporated herein by reference in its entirety.

The frame 12 includes a bar or tongue 18 mountable in the hitch receiver of the truck so as to extend rearwardly behind the truck. A cross bar or arm 20 is mounted on the rear end of the tongue 18 and extends laterally at a position spaced rearwardly from the rear edge of the open tailgate of the truck. The rearward end of the tongue is preferably inclined upwardly to support the cross bar 20.

The ski ramps 16 are pivotally mounted on the cross bar 20 for movement between a lowered, inclined use position for loading and unloading the snowmobile and a raised transport position. The ski ramps 16 are spaced apart to align with the skis of the snowmobile. Each ski ramp has telescoping sections 24, 26. A spring loaded lock pin 27 extends through a hole in the ramp section 24 and one or more holes (not shown) in the ramp section 26 to lock the ramp sections together, such as when the ramps 16 are in the transport position or otherwise not in use.

Each ramp 16 has a transverse tube 28 which slideably and rotatably fits over the bar 20 and is retained in any convenient manner, such as a pin. The tube 28 can be square or round. The forward ends of the ramps 16 extend forwardly from the cross bar 20, and are spaced rearwardly from the rear edge of the opened tailgate when the ramps are in the loading/unloading position. The height of the cross bar 20 is at an elevation lower than the horizontal plane of the opened tailgate.

The cross car 20 is slideably mounted on the tongue 18 using a tubular collar fixed in a desired position along the tongue 18 by one or more set bolts. A secondary cross bar or arm 34 may be provided on the tongue 18 to limit the rotation of the ramps 16 on the cross bar 20. The cross bar 34 may be adjustably mounted on the tongue 18 via a tubular collar with one or more set bolts which can be tightened to hold the cross bar 34 in a selected position along the tongue 18.

Another cross bar or arm 40 may be provided on the tongue 18 and slideably positioned via a collar with one or more set bolts so as to be positioned adjacent and below the rear bumper of the truck. The cross bar 40 protects the truck bumper from being hit by the ramps 16, such as when the telescoping ramp sections 24, 26 are retracted to the transport position.

The ramp assembly 10 may be provided with brake lights on one of the cross bars 20, 34 or 40. The lights are preferably electrically coupled to the brake system of the truck via a wiring harness. As an alternative or in addition to the brake lights, the assembly can have reflectors strategically placed to increase visibility of the assembly 10 after dark to a vehicle following the truck.

The center ramp 14 is preferably made from two sections 50, 52, which are hinged or otherwise pivotally coupled so that ramp 14 can be unfolded for use and folded for storage. In an alternative embodiment, the center ramp 14 may be rigid or one piece, without folding. The forward end of the ramp 14 includes one or more clamps or other attachment mechanism 54 for detachably mounting the ramp 14 to the crossbar 20 of the frame 12. The clamps 54 may take various forms, which provides for quick and easy coupling of the center ramp 14 to the cross bar 20.

A pedestal 56 may be mounted on the frame 12 to support the rear end of the snowmobile that over extends rearwardly beyond the tailgate of the truck. In a preferred embodiment, the pedestal 56 includes a lower tube 58 which slideably fits over the tongue 18 and can be fixed in position by any convenient means, such as a set bolt threaded through a collar 58. A tube 60 is welded or otherwise secured to the collar 58 and extends upwardly for receipt of a post 62. A support plate 64 is fastened to the top of the post 62 using bolts, or alternatively, by welding or other known connection means. Preferably, the support member 64 is in the form of a U-shaped channel so as to receive one of the transverse treads of the snowmobile track or belt. The collar 58 allows the pedestal 56 to be slideably positioned along the tongue 18, as needed.

A ramp extension 66 may be slideably mounted on the front or upper end of each ski ramp 16, so as to rest upon the tailgate when the ramps 16 are in the use position. The extensions 66 may be installed after the ski ramps 16 are pivoted to the use position and after the tailgate is opened. The ramp extension 66 may telescope in or over the end of the ski ramps 16 for quick and easy installation and removal. The ramp extensions 66 are a preferred option, though it is understood that the extensions 66 are not required in order to load and unload a snowmobile to and from the truck bed.

The ramps 16 are preferably made of aluminum so as to be light weight and easy to handle. The snowmobile skis are typically made from plastic, with a carbide or other hard metal rod or runner embedded therein. This metal component is very sharp and can damage the rungs of the ski ramps 16 as the snowmobile is driven up and down the ramps. Therefore, protective rung covers 68 are preferably mounted to or over the rungs of the ski ramps 16 so as to prevent damage thereto from the snowmobile skis. The covers 68 prevent the skis from cutting the aluminum ramps 16. In a preferred embodiment, the covers 68 are provided on one surface of the ramps 16 for use of snowmobiles, while the opposite surface remains as exposed aluminum such that the ramps can be turned or flipped over for use in loading an ATV or golf cart in a manner described in Applicant's U.S. Pat. No. 9,745,153. The rung covers 68 may cover individual rungs of the ramps 16 or may be elongated so as to cover multiple rungs. For clarity, the drawings only show protective covers 68 on the lowest rungs, but it is understood that the protectors are preferably provided on all the rungs. The elongated covers may be pinned to the side rails of the ramps 16, while the individual rung covers may be attached directly to the rungs.

In use, to load a snowmobile into the truck bed, the tongue 18 is pinned into the hitch receiver of the truck, and the ramps 16 are telescoped outwardly and positioned with the rear ends on the ground. The lateral spacing between the ramps 16 is adjusted on the bar 20 to align with the skis of the snowmobile. The ramp extensions 66 may be installed so as to rest on the rear of the tailgate, and locked in position with a pin extending through at least one side of the extension and one side of the ramps 16. The center ramp 14 is mounted to the bar 20. The snowmobile is then driven upwardly on the inclined ramps 14, 16 and forwardly into the truck bed. Then, the extension 66 may be removed, and the telescoping rear ends 26 of the ramps 16 can be retracted and fixed by lock pins for transport, without removing the ramps from the cross bar. The center ramp 14 is detached and placed in the truck for transport. The pedestal 56 supports the rear end of the snowmobile behind the truck tailgate.

To unload the snowmobile from the truck bed, the process is reversed. The telescoping ramp sections 26 are extended, the extension 66 are installed, the center ramp 14 and mounted to the bar 20, and then the snowmobile is driven rearwardly from the truck bed.

The invention has been shown and described above with the preferred embodiments, and it is understood that many modifications, substitutions, and additions may be made which are within the intended spirit and scope of the invention. From the foregoing, it can be seen the present invention accomplishes at least all of its stated objectives.

What is claimed:

1. A snowmobile ramp assembly for loading and unloading a snowmobile into and out of a pickup truck, the truck having a tailgate movable between open and closed positions, and a hitch receiver, comprising:
a tongue having opposite front and rear ends, and the front end being adapted to mount in the hitch receiver;
a first cross bar on the tongue;
first and second ramps each having opposite forward and rearward ends and being pivotally mounted on the cross bar between the opposite ramp ends whereby the ramps pivot between a use position, with the rear ends on the ground and the forward ends, at an elevation substantially level with the tailgate and spaced from the tailgate and a transport position, with the rear ends raised off the ground; and
a center ramp between the first and second ramps and having a front end removably mounted on the cross bar and a rear end to engage the ground in a use position.

2. The ramp assembly of claim 1 wherein the first and second ramps have telescoping sections.

3. The ramp assembly of claim 1 wherein the center ramp has folding sections.

4. The ramp assembly of claim 1 further comprising first and second ramp extensions mounted on the forward ends of the first and second ramps as to engage the tailgate in the use position.

5. The ramp assembly of claim 1 wherein the first and second ramps are inclined upward from the rear ends in the use position and inclined downwardly from the rear ends in the transport position.

6. The ramp assembly of claim 1 wherein the ramps each include opposite side rails and a plurality of rungs extending between the side rails.

7. The ramp assembly of claim 6 further comprising rung protectors covering an upper surface of the rungs on the first and second ramps.

8. The ramp assembly of claim 1 wherein the first and second ramps are spaced apart to align with skis on the snowmobile.

9. The ramp assembly of claim 1 further comprising a pedestal on the tongue and having an upper end adapted to support a rear end of the snowmobile when the snowmobile is loaded in the truck.

10. A method of loading and unloading a snowmobile to and from a pickup truck bed having an open tailgate, comprising:
mounting a ramp assembly to a hitch receiver on the truck, the ramp assembly having first and second spaced apart ramps on a cross bar with opposite forward and rearward ends;
pivotally supporting the first and second ramps on the cross bar at a pivot point between the ends at a location behind the tailgate for movement between an inclined use position and a raised transport position;
positioning the first and second ramps in the use position such that the forward ends of the first and second ramps are at an elevation substantially level with the open tailgate;
detachably mounting a center ramp to the cross bar between the first and second ramps as to incline downwardly and rearwardly to the ground;
driving the snowmobile on the first, second and center ramps into and out of the truck bed.

11. The method of claim 10 wherein the rear ends of the first and second ramps are on the ground in the use position and off the ground in the transport position.

12. The method of claim 10 further comprising telescoping sections of the first and second ramps between the use and transport positions.

13. The method of claim 10 further comprising supporting each ramp only on the ground and on the cross bar, without support on the tailgate, in the use position.

14. The method of claim 10 wherein the first and second ramps slope upwardly from front to back in the transport position.

15. The method of claim 10 further comprising supporting the rear end of the snowmobile on a pedestal behind the tailgate when the snowmobile is loaded in the truck bed.

16. A ramp assembly for loading and unloading a snowmobile into and out of a truck bed, the snowmobile having a pair of front skis and a center drive belt, and the truck having a tailgate and a hitch receiver, the ramp assembly comprising:
a frame mountable in the hitch receiver;
a pair of spaced apart ski ramps pivotally mounted on the frame for movement between a lowered use position for supporting the snowmobile skis during loading and unloading of the snowmobile, and a raised transport position; and
a center ramp on the frame between the ski ramps for supporting the snowmobile drive belt during loading and unloading of the snowmobile.

17. The ramp assembly of claim 16 further comprising a pedestal extending upwardly from the frame to support a rear end of the snowmobile behind the tailgate.

18. The ramp assembly of claim 16 wherein the center ramp is removed from the frame after the snowmobile is loaded in the truck bed.

19. The ramp assembly of claim 16 wherein each ramp has spaced apart rails and rungs between the rails.

20. The ramp assembly of claim 16 wherein the ski ramps are upwardly and rearwardly inclined in the transport position, and downwardly and rearwardly inclined in the use position.
